(19) United States
(12) Patent Application Publication
(10) Pub. No.: US 2024/0308382 A1
(43) Pub. Date: Sep. 19, 2024

(54) ACTIVATING A RESERVED CHARGING COLUMN OF A CHARGING STATION

(71) Applicant: AUDI AG, Ingolstadt (DE)

(72) Inventors: Ewald KREML, Ingolstadt (DE); Matthias SCHEIDER, Sappenfeld (DE)

(21) Appl. No.: 18/603,898

(22) Filed: Mar. 13, 2024

(30) Foreign Application Priority Data
Mar. 14, 2023 (DE) 102023106338.3

(51) Int. Cl. B60L 53/66; B60L 53/31; B60L 53/62; B60L 53/65; B60L 53/68

(52) U.S. Cl. CPC B60L 53/66; B60L 53/31; B60L 53/65; B60L 53/68; B60L 53/62; B60L 2240/80; B60L 2250/16

(57) ABSTRACT

A method for reserving a charging column of a charging station is disclosed and may include determining a designated charging column of a selected charging station by a cloud server, reserving the designated charging column of the selected charging station by the cloud server, and ascertaining approach information concerning driving of the electric vehicle within the selected charging station to the designated charging column by the cloud server.

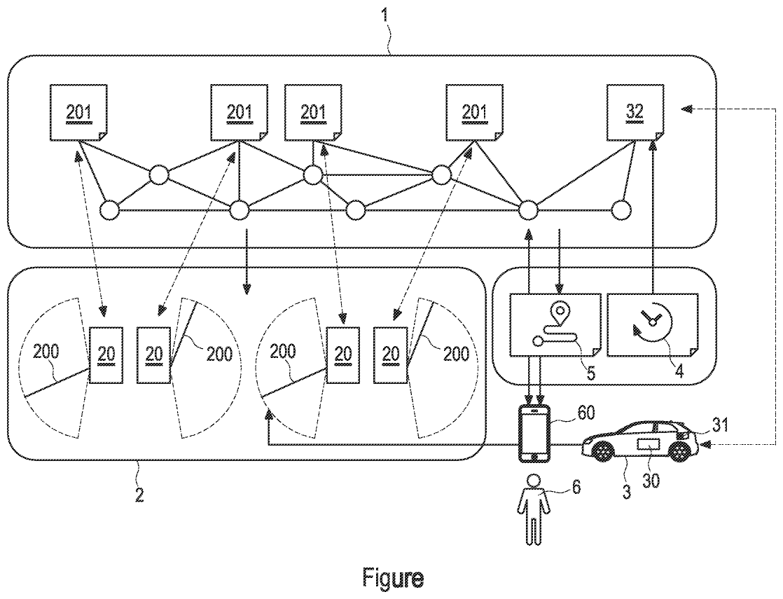

### BACKGROUND

### Technical Field

The present disclosure relates to a charging station, specifically a method for reserving a charging station.

### Description of the Related Art

Methods for reserving a charging column of a charging station are part of the prior art in different embodiments, and serve to enable convenient and efficient charging of an electric vehicle. The methods preclude an electric vehicle from unsuccessfully activating a defective charging station or having to wait to charge at an occupied charging station, or a charging column failing to provide a maximum charging power of the electric vehicle, which unnecessarily prolongs the duration of the charging.

For example, CN 109606151A discloses a method for reserving a charging column of a charging station, wherein a cloud server stores and continuously updates charging schedules of a plurality of charging stations, and upon a request from a mobile terminal, determines and reserves a suitable charging station and/or charging column based on the present charging schedules, and transmits the reservation that is made to the mobile terminal.

Similar methods are also known from WO 2014/131449A1 and EP 3702201A1.

However, satisfaction of a driver of the electric vehicle grows with each gain in convenience and efficiency during charging of the electric vehicle.

### BRIEF SUMMARY

The present disclosure provides a method for reserving a charging column of a charging station, which further increases the efficiency of charging of an electric vehicle and further simplifies the charging of the electric vehicle.

The subject matter of the present disclosure relates to a method for reserving a charging column of a charging station, wherein a cloud server reserves a designated charging column of a selected charging station, and the cloud server determines the charging column. The charging station may include a plurality of charging columns, i.e., charging bays each having a high-voltage connection and/or an induction coil. Any customary mobile terminal may provide a connection to the cloud server, and via the provided connection may make a reservation request to the cloud server by use of an application (i.e., “app”) that is installed in the mobile terminal. By using the app, a user of the mobile terminal may select a charging station and indicate the selected charging station as part of the reservation request.

The reservation of the designated charging column may be implemented by way of an automatically driven, movable mechanical barrier that prevents another electric vehicle from approaching. The movable mechanical barrier may be removed when the electric vehicle reaches the charging station for which the charging column is reserved. The charging station may identify the electric vehicle by sensor, for example, based on a license plate of the electric vehicle.

According to the present disclosure, the cloud server may determine the charging column based on data of an electric vehicle and data of the selected charging station, and based on the data of the electric vehicle and the data of the selected charging station, the cloud server ascertains approach information concerning driving of the electric vehicle within the charging station to the designated charging column. The data of the electric vehicle may enable the cloud server to determine a suitable charging column, from multiple charging columns of the selected charging station, that is optimized specifically for the electric vehicle.

The additional approach information may simplify activation of the designated charging column and/or connection of the electric vehicle to the high-voltage connection of the charging column via a charging cable, and/or an optimal configuration of the electric vehicle relative to an induction coil of the charging column.

Due to the charging column that is specifically determined for the electric vehicle, efficiency of the charging may be optimized. The approach information may optimize convenience in using the charging station.

The maximum charging power, the position of a charging connection, and/or the size of the electric vehicle may be ascertained as the data of the electric vehicle. The indicated data of the electric vehicle are not to be construed as exclusive. The cloud server may store the data of the electric vehicle.

For example, the cloud server may ascertain the data of the electric vehicle by way of an identifier of the electric vehicle. The identifier may include the license plate of the electric vehicle, a vehicle identification number (VIN), a model name, and the like. The data of the electric vehicle may be assigned to the identifier, for example as the result of the driver registering on the cloud server.

The number of charging columns, the configuration and orientation of each charging column, the average capacity utilization, the maximum charging power, the probability of failure, the availability, the length of a charging cable, and/or the frequency of a reduction in the charging power of each charging column may be ascertained as the data of the charging station. The indicated data of the charging station are not to be construed as exclusive. The cloud server may store the data of a plurality of charging stations.

In one embodiment, the cloud server may transmit the ascertained approach information to a mobile terminal of a driver of the electric vehicle, and the driver may manually activate the designated charging column based on the transmitted approach information. This refinement may be suited for an electric vehicle without an autonomous operating mode, or an electric vehicle that is not operated in an autonomous operating mode during activation of the charging station.

In an alternative embodiment, the cloud server may transmit the ascertained approach information to a driver assistance system of the electric vehicle, and the driver assistance system may at least semiautonomously activate the designated charging column based on the transmitted approach information. This refinement may be suitable for an electric vehicle with an autonomous operating mode, and which is operated in the autonomous operating mode during activation of the charging station.

The charging column may be determined as a function of a selected charging period. The charging period may be selected using the mobile terminal, such as via the app, and may be part of the reservation request.

The electric vehicle may independently select the charging station and the charging period. During travel, the electric vehicle may detect at any time a position and a state of charge (SoC) of the traction battery. The electric vehicle may select the charging station and the charging period as a function of the detected position and the detected state of charge, i.e., the distance from the charging station and the cruising range of the electric vehicle, while a mobile terminal may automatically transmit the reservation request and indicate the selected charging station and the selected charging period as part of the reservation request.

The cloud server may reserve the designated charging column for the selected charging period. In this way, the cloud server may hold the designated charging column open for the selected charging period, thus avoiding waiting time of the electric vehicle prior to the charging.

In addition, the designated charging column may provide a visually perceivable signal at the start of the selected charging period. The visually perceivable signal may be a light signal that is emitted by a lamp assigned to the charging column. The light signal may have a variable intensity and/or color and/or emission direction. The lamp may be designed as an illuminating trajectory, situated underground beneath the charging station, to the designated charging column. The visually perceivable signal may increase the convenience for manual driving in the charging station.

The high efficiency of charging of an electric vehicle and the simple charging of the electric vehicle may result in a high satisfaction level for a driver of the electric vehicle.

### BRIEF DESCRIPTION OF THE SEVERAL VIEWS OF THE DRAWINGS

The FIGURE shows a schematic view of a system for carrying out a method for reserving a charging column of a charging station.

### DETAILED DESCRIPTION

The FIGURE shows a component-by-component view of a system for carrying out a method according to an embodiment of the disclosure for reserving a charging column 20 of a charging station 2.

The system comprises the charging station 2 with a plurality of charging columns 20, each of which may include a charging cable 200, a cloud server 1, and an electric vehicle 3. The electric vehicle 3 may include a driver assistance system 30 and a charging connection 31. In addition, the system may include a mobile terminal 60 of a driver 6.

For reserving a charging column 20 of the charging station 2, the system may be configured to carry out a method according to one embodiment of the disclosure as follows.

The electric vehicle 3 may independently select the charging station 2 and a charging period 4.

The cloud server 1 may determine a charging column 20 of the selected charging station 2 based on data 32 of the electric vehicle 3 and data 201 of the selected charging station 2. In some embodiments, the charging column 20 may also be determined based on the selected charging period 4.

The maximum charging power, the position of a charging connection 31, and/or the size of the electric vehicle 3 may be ascertained by the cloud server 1 as the data 32 of the electric vehicle 3. The cloud server 1 may ascertain the data 32 of the electric vehicle 3 by way of an identifier of the electric vehicle 3.

The number of charging columns 20, the configuration and orientation of each charging column 20, the average capacity utilization, the maximum charging power, the probability of failure, the availability, the length of a charging cable 200, and/or the frequency of a reduction in the charging power of each charging column 20 may be ascertained by the cloud server 1 as the data 201 of the charging station 2.

The cloud server 1 reserves the designated charging column 20 of the selected charging station 2, and for the selected charging period 4 in some embodiments.

Based on the data 32 of the electric vehicle 3 and the data 201 of the selected charging station 2, the cloud server may ascertain approach information 5 concerning driving of the electric vehicle 3 within the charging station 2 to the designated charging column 20.

The cloud server 1 may transmit the ascertained approach information 5 to a mobile terminal 60 of a driver 6 of the electric vehicle 3. The driver 6 may manually activate the designated charging column 20 based on the transmitted approach information 5.

Alternatively, the cloud server 1 may transmit the ascertained approach information 5 to the driver assistance system 30 of the electric vehicle 3, and the driver assistance system 30 may at least semiautonomously activate the designated charging column 20 based on the transmitted approach information 5.

In addition, the designated charging column 20 may provide a visually perceivable signal at the start of the selected charging period 4.

German patent application no. 102023106338.3, filed Mar. 14, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for reserving a charging column of a charging station, the method comprising:
determining a designated charging column of a selected charging station, by a cloud server, based on data of an electric vehicle and data of the selected charging station;
reserving the designated charging column of the selected charging station by the cloud server; and
ascertaining approach information concerning driving of the electric vehicle within the selected charging station to the designated charging column by the cloud server, based on the data of the electric vehicle and the data of the selected charging station.

2. The method according to claim 1, wherein at least one of a maximum charging power, a position of a charging connection, and a size of the electric vehicle is ascertained as the data of the electric vehicle.

3. The method according to claim 1, wherein the cloud server ascertains the data of the electric vehicle by an identifier of the electric vehicle.

4. The method according to claim 1, wherein at least one of a number of charging columns, a configuration and orientation of each charging column, an average capacity utilization, a maximum charging power, a probability of failure, an availability, a length of a charging cable, and a frequency of a reduction in charging power of each charging column is ascertained as the data of the charging station.

5. The method according to claim 1, further comprising:
transmitting the ascertained approach information to a mobile terminal of a driver of the electric vehicle by the cloud server; and
manually activating the designated charging column based on the transmitted approach information by the driver.

6. The method according to claim 1, further comprising:
transmitting the ascertained approach information to a driver assistance system of the electric vehicle by the cloud server; and
at least semiautonomously activating the designated charging column based on the transmitted approach information by the driver assistance system.

7. The method according to claim 1, wherein the designated charging column is determined as a function of a selected charging period.

8. The method according to claim 7, wherein the selected charging station and the selected charging period are selected independently of each other.

9. The method according to claim 7, further comprising reserving the designated charging column for the selected charging period by the cloud server.

10. The method according to claim 7, further comprising providing a visually perceivable signal at a start of the selected charging period by the designated chagrining column.
